(19) United States
(12) Patent Application Publication
(10) Pub. No.: US 2011/0195748 A1
(43) Pub. Date: Aug. 11, 2011

(54) ENHANCED SECURITY FEATURE FOR PAYMENT-ENABLED MOBILE TELEPHONE

(76) Inventors: Jonathan Main, Hook (GB); Simon Phillips, York (GB); Ronald D. Carter, Barrington, Cambs (GB)

(21) Appl. No.: 12/765,246

(22) Filed: Apr. 22, 2010

Related U.S. Application Data
(60) Provisional application No. 61/302,613, filed on Feb. 9, 2010.

(51) Int. Cl. H04M 1/66; G06Q 30/00; G06Q 20/00; G06F 3/048

(52) U.S. Cl. 455/557; 705/18; 705/17; 715/764

(57) ABSTRACT

A method includes providing a mobile device. The mobile device is programmed with a payment application program, an environment program that supports application programs, and a user interface application program. When the user interface application program is initiated, the initiation of the program includes sending a message from the user interface application program to the payment application program to clear a PIN (personal identification number) verification status flag.

### CROSS-REFERENCE TO RELATED APPLICATION

This application claims the benefit of U.S. provisional patent application Ser. No. 61/302,613, filed Feb. 9, 2010, and incorporated herein by reference.

### BACKGROUND

Payment cards such as credit or debit cards are ubiquitous. For decades, such cards have included a magnetic stripe on which the relevant account number is stored. To consummate a purchase transaction with such a card, the card is swiped through a magnetic stripe reader that is part of a point of sale (POS) terminal. The reader reads the account number from the magnetic stripe. The account number is then used to route a transaction authorization request that is initiated by the POS terminal.

In pursuit of still greater convenience and more rapid transactions at POS terminals, payment cards have more recently been developed that allow the account number to be automatically read from the card by radio frequency communication between the card and a so-called “proximity reader” which may be incorporated with the POS terminal. In such cards, often referred to as “proximity payment cards” or “contactless payment cards”, a radio frequency identification (RFID) integrated circuit (IC, often referred to as a “chip”) is embedded in the card body. (The term ‘RFID’ should be understood to encompass ISO14443 communication or any other contactless communication technique used by proximity payment cards.) A suitable antenna is also embedded in the card body and is connected to the RFID chip to allow the chip to receive and transmit data by RF communication via the antenna. In typical arrangements, the RFID chip is powered from an interrogation signal that is transmitted by the proximity reader and received by the card antenna.

MasterCard International Incorporated, the assignee hereof, has established a widely-used standard, known as “PayPass”, for interoperability of contactless payment cards and proximity readers.

It has been proposed that the capabilities of a contactless payment card be incorporated into a mobile telephone, thereby turning the mobile telephone into a contactless payment device. Typically a mobile telephone/contactless payment device (also referred to as a “payment-enabled mobile telephone”) includes integrated circuitry with the same functionality as the RFID IC of a contactless payment card. In addition, the mobile telephone/contactless payment device includes a loop antenna that is coupled to the payment-related IC for use in sending and/or receiving messages in connection with a transaction that involves contactless payment.

As with all payment devices, it is desirable that certain security measures be taken to prevent unauthorized use of payment-enabled mobile telephones. For example, it may be required, at least for relatively high-value transactions, that the user enter a personal identification number (PIN) into the phone keypad before entering into a transaction using the payment-enabled mobile telephone. The present inventors have now recognized a need for a novel security procedure, implemented in software that programs the payment-enabled mobile telephone, to provide additional protection against unauthorized use.

### BRIEF DESCRIPTION OF THE DRAWINGS

FIG. 1 schematically illustrates some physical aspects of a purchase transaction performed using a payment-enabled mobile telephone.

FIG. 2 schematically illustrates some communication aspects of the purchase transaction illustrated in FIG. 1.

FIG. 3 is a block diagram representation of a payment-enabled mobile telephone in which the present invention may be implemented.

FIG. 4 schematically illustrates some of the software aspects of the payment-enabled mobile telephone of FIG. 3.

FIG. 5 schematically illustrates aspects of operation, in accordance with an aspect of the present invention, of a user interface application program that is represented in FIG. 4.

FIGS. 6-9 are flow charts that illustrate processes that may be performed in accordance with aspects of the present invention in the payment-enabled mobile telephone of FIG. 3.

### DETAILED DESCRIPTION

In general, and for the purpose of introducing concepts of embodiments of the present invention, a software-based alarm is set in a payment-enabled mobile telephone to assure that a transaction-ready status of a payment application is cleared after a pre-determined period of time, even if the user interface application fails to terminate operation properly. This can prevent the payment-enabled telephone from being in an unsecured condition for an extended period of time in the event of a glitch in the user interface application, and thus reinforces a requirement for user authentication/PIN entry for at least some transactions using the payment-enabled mobile telephone.

This software-based alarm may supplement and back up a time-out period conventionally maintained in the user interface application to time-out the transaction-ready status of the payment application after entry and verification of the user's PIN. The software-based alarm may be provided in a virtual machine program or operating system that supports the user interface application.

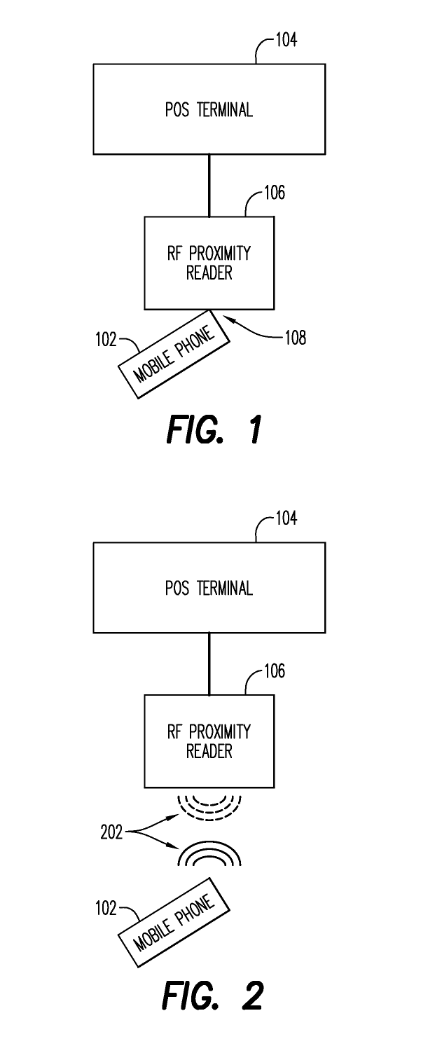

FIG. 1 schematically illustrates some physical aspects of a purchase transaction performed using a payment-enabled mobile telephone 102 provided in accordance with aspects of the present invention. This transaction may in general terms be performed in accordance with conventional proposals for transactions of the type described in an earlier portion of this disclosure. A conventional POS terminal is represented at block 104 in FIG. 1, and block 106 represents a conventional proximity reader interfaced to or incorporated in the POS terminal 104. To allow the payment-enabled mobile telephone 102 to upload the payment card account number to the POS terminal 104 and otherwise to communicate with the POS terminal 104, the user may tap the payment-enabled mobile telephone 102 on the proximity reader 106, as indicated at 108 in FIG. 1.

FIG. 2 schematically illustrates some communication aspects of the purchase transaction illustrated in FIG. 1. As in FIG. 1, the POS terminal 104 and the proximity reader 106 are shown, as is the payment-enabled mobile telephone 102. Wireless communication between the payment-enabled mobile telephone 102 and the proximity reader 106 is indicated at 202. In some embodiments, for example, the communication may be carried out in accordance with the above-mentioned PayPass standard. Via the wireless communication 202, the payment-enabled mobile telephone 102 uploads the payment card account number to the POS terminal 104. The wireless communication 202 may also implement handshaking signals, device authentication, security procedures, etc.

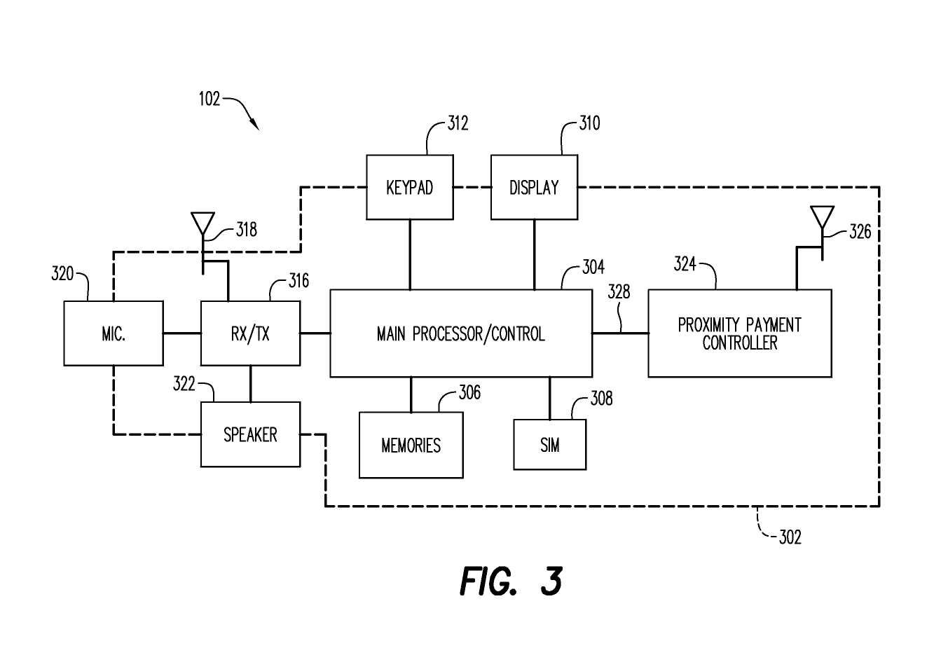

FIG. 3 is a schematic block diagram of an example embodiment of the payment-enabled mobile telephone 102. (FIG. 3 does not necessarily represent the physical layout of the payment-enabled mobile telephone 102.) In its hardware and in much of its software/firmware, the payment-enabled mobile telephone 102 may be entirely conventional.

The payment-enabled mobile telephone 102 may include a conventional housing (indicated by dashed line 302 in FIG. 3) that contains and/or supports the other components of the payment-enabled mobile telephone 102. The payment-enabled mobile telephone 102 further includes conventional control circuitry 304, for controlling over-all operation of the payment-enabled mobile telephone 102. (The control circuitry 304 may for example be similar to—or the same as—a conventional microprocessor, and accordingly may be referred to as a “processor”.) Other components of the payment-enabled mobile telephone 102, which are in communication with and/or controlled by the control circuitry 304, include: (a) one or more memory devices 306 (e.g., program and working memory, etc.); (b) a conventional SIM (subscriber identification module) card 308 (also referred to as a “universal integrated circuit card” or “UICC”, which may store and run a SIM application, which is not separately shown); (c) a conventional keypad 310 for receiving user input; and (d) a conventional display 312 for displaying output information to the user. In some embodiments, both the keypad and the display may be implemented with a touch screen that displays a virtual keypad. Hence the term “keypad” should be understood to include a touch screen.

The payment-enabled mobile telephone 102 also includes conventional receive/transmit circuitry 316 that is also in communication with and/or controlled by the control circuitry 304. The receive/transmit circuitry 316 is coupled to an antenna 318 and provides the communication channel(s) by which the payment-enabled mobile telephone 102 communicates via the mobile network (not shown). The payment-enabled mobile telephone 102 further includes a conventional microphone 320, coupled to the receive/transmit circuitry 316. Of course, the microphone 320 is for receiving voice input from the user. In addition, a loudspeaker 322 is included to provide sound output to the user, and is coupled to the receive/transmit circuitry 316.

In conventional fashion, the receive/transmit circuitry 316 operates to transmit, via the antenna 318, voice signals generated by the microphone 320, and operates to reproduce, via the loudspeaker 322, voice signals received via the antenna 318. The receive/transmit circuitry 316 may also handle transmission and reception of text messages and/or other data communications via the antenna 318.

The payment-enabled mobile telephone 102 may also include circuitry 324 that functions as a “payment circuit”. That is, the payment circuit 324 may store a payment card account number that identifies a payment card account that has been issued to the individual who owns the payment-enabled mobile telephone 102. Further, the payment-enabled mobile telephone 102 may include a loop antenna 326 coupled to the payment circuit 324. The payment circuit 324 may operate so as to interact with an RFID/NFC proximity reader (e.g., item 106 in FIGS. 1 and 2) of a POS terminal (e.g., item 104 in FIGS. 1 and 2) to provide the payment card account number (stored in the payment circuit 324) for a purchase transaction at the POS terminal. For example, the payment circuit 324 may be programmed to operate in accordance with the above-mentioned “PayPass” standard.

(Although payment circuit 324 is illustrated in FIG. 3 as being separate from control circuitry 304, in practice the payment circuit 324 may be integrated with control circuitry 304, SIM card 308 and/or memory 306, such that the functionality ascribed herein to payment circuit 324 is implemented by suitable software programming—e.g., a conventional mobile payment application program—stored in the memory 306 and/or the SIM card 308 to control the control circuitry 304 to perform payment-related functions. Details of such software, as provided in accordance with aspects of the present invention, will be described below.)

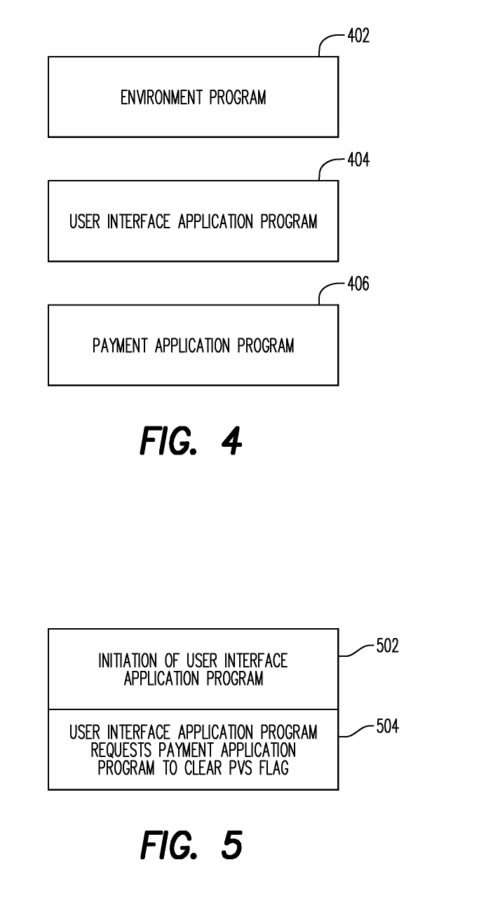

FIG. 4 schematically illustrates some of the software aspects of the payment-enabled mobile telephone 102 depicted in FIG. 3. The basic software architecture for the payment-enabled mobile telephone 102 may be conventional, and may include a program 402 (hereinafter referred to as the “environment program”) which provides an environment for supporting application programs to run on the control circuitry 304. For example, the environment program 402 may be a conventional mobile operating system or kernel. In some embodiments, the environment program 402 may be implemented as a Java virtual machine which operates on top of a conventional operating system (OS) for a mobile telephone.

A user interface application program 404 also is stored in and runs in the payment-enabled mobile telephone 102. The user interface application program 404 may be implemented as a so-called “MIDlet” in accordance with a Java mobile information device profile (MIDP). The user interface application program 404 includes novel features in accordance with the present invention, as described below, but otherwise may be generally conventional in its operation. The environment program 402, too, may be conventional, except for behaviors elicited in response to novel features of the user interface application program 404.

The payment-enabled mobile telephone 102 also stores and runs a payment application program 406. The payment application program 406 may be conventional in its operation, and may be supported by a mobile OS (not separately shown), such as is mentioned above. The payment application program 406 may also be referred to as an “applet”.

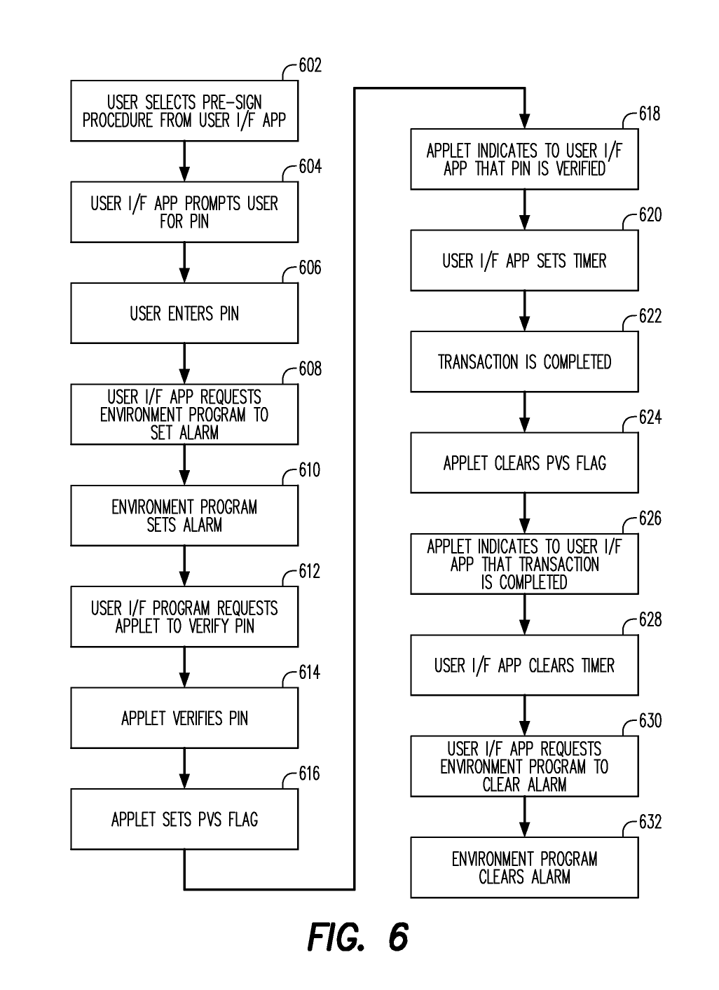

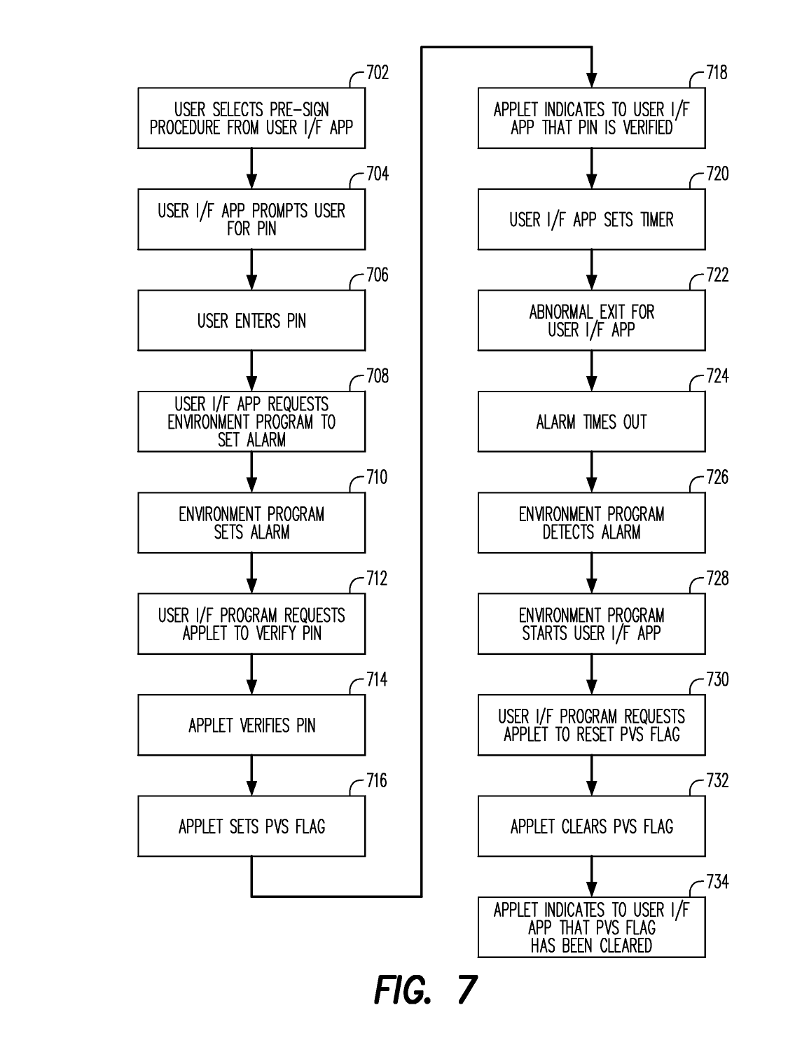

FIG. 5 schematically illustrates aspects of operation, in accordance with an aspect of the present invention, of the user interface application program 404 that is represented in FIG. 4. In particular, FIG. 5 illustrates one salient novel feature of the user interface application program 404. The purpose of this feature will later be understood more clearly in light of subsequent discussion of the operating context for this feature. In any event, in accordance with an aspect of the present invention, when the user interface application program 404 is initiated or launched (e.g., upon the payment-enabled mobile telephone 102 being powered up, or as will be seen, in response to a re-start of the user interface application program 404 initiated by the environment program 402), as indicated at 502, then activity represented by block 504 is included in the launching of the user interface application program 404. At 504, the user interface application program 404 requests the payment application program 406 (e.g., by a message passed from the user interface application program 404 to the payment application program 406) to clear a flag known as the PVS flag. As will be better understood from discussion below of FIGS. 6-9, “PVS” stands for “PIN verification status”, and the corresponding flag performs a function related to enabling the payment application program 406 to consummate purchase transactions, while enforcing certain security measures.

FIG. 6 is a flow chart that illustrates a process that may be performed by the payment-enabled mobile telephone 102 in accordance with aspects of the present invention. The process of FIG. 6 corresponds to what could be called a “normal transaction” scenario, i.e., a sequence of events that occur when the payment-enabled mobile telephone 102 is operated successfully to consummate a transaction at a POS terminal. For purposes of this and other scenarios described below, it will be assumed that the environment program 402, the user interface application program 404 and the payment application program 406 are all currently open and operating on the payment-enabled mobile telephone 102 at the commencement of the scenario.

At 602 in FIG. 6, the user selects an option from a menu or the like by which the user indicates that he/she wishes to “pre-sign” for a transaction. That is, the user wishes to enter his/her PIN to allow the transaction to go forward, and wishes to do so before interfacing the payment-enabled mobile telephone 102 to the proximity reader of the POS terminal. For present purposes it will be assumed that the operation of the payment application program 406 is such that the user must enter his/her PIN for each transaction or at least for transactions for which the amount to be paid is above a certain threshold level (i.e., “high value” transactions). Further (and as will be seen), it is assumed that the desired payment capability of the payment application program 406 is enabled for a predetermined period of time (say 5 minutes) after the user enters his/her PIN. Thus, the payment application program 406 enters an “enabled” state upon entry and verification of the user's PIN and remains in that state for the predetermined period of time, before being switched back to a disabled state. The enabled vs. disabled state of the payment application program 406 may correspond to the state (set vs. cleared, respectively) of the above-mentioned PVS flag.

Selection of the pre-sign procedure may be in accordance with conventional operation of the user interface application program 404.

Next, at 604, the user interface application program 404 prompts the user to enter his/her PIN into the payment-enabled mobile telephone 102. This, too, may occur in accordance with conventional operation of the user interface application program 404.

Then, at 606, the user enters his/her PIN into the payment-enabled mobile telephone 102. This may occur in accordance with conventional operation of the user interface application program 404, and may be accomplished by the user's operation of the above-mentioned keypad 310 (FIG. 3).

Continuing to refer to FIG. 6, at 608 the user interface application program 404 requests the environment program 402 to set an alarm. This is a novel feature of the user interface application program 404, provided in accordance with aspects of the present invention. This step may take advantage of a conventional facility provided by the environment program 402 in which MIDlets or like programs supported by the environment program 402 are permitted to register for alarms or other events. For example, in the Java virtual machine referred to above, this facility may be implemented as a “push registry”.

The time-out period for the alarm may, for example, be a few minutes longer than the pre-determined period during which the payment application program 406 is transaction-enabled after verification of the user's PIN.

At 610, and in response to the request made by the user interface application program 404 at 608, the environment program 402 sets the alarm requested by the user interface application program 404.

At 612, the user interface application program 404 requests the payment application program 406 to verify the user's PIN as entered at step 606. This may be done in accordance with conventional operation of the user interface application program 404.

At 614, the payment application program 406 verifies the user's PIN. This may occur in accordance with conventional operation of the payment application program 406. For example, and as will be familiar to those who are skilled in the art, the user's PIN may have previously been stored in a secure manner (e.g., in the SIM card 308, FIG. 3) in the payment-enabled mobile telephone 102, and accessible to the payment application program 406. The payment application program 406 may retrieve the stored PIN and compare it to the PIN as entered by the user and passed to the payment application program 406 from the user interface application program 404. If the entered PIN matches the stored and retrieved PIN, then the payment application program 406 deems the entered PIN to have been verified.

At 616, in response to verifying the user's PIN, the payment application program 406 sets the above-mentioned PVS flag, thereby placing itself in the transaction-enabled state. This also may occur in accordance with conventional operation of the payment application program 406.

At 618, the payment application program 406 indicates to the user interface application program 404 that the payment application program 406 has verified the user's PIN. This also may occur in accordance with conventional operation of the payment application program 406.

At 620, and in response to the indication from the payment application program 406 that the PIN is verified, the user interface application program 404 may set a timer that is maintained within the user interface application program 404 itself. The time-out period for this timer may be equal to (and thus may implement) the pre-determined period during which the payment-enabled mobile telephone 102 is to be transaction-enabled after entry of the user's PIN.

At 622, and in a conventional manner, the payment-enabled mobile telephone 102 is interfaced to the proximity reader of the POS terminal (as in FIGS. 1 and 2), such that the payment application program 406 exchanges communications with the POS terminal and uploads the payment account number stored in the payment-enabled mobile telephone 102 to the POS terminal in order to consummate the desired purchase transaction.

At 624, in response to successful completion of the purchase transaction, the payment application program 406 clears the PVS flag. This may be done in accordance with conventional operation of the payment application program 406.

At 626, the payment application program 406 indicates to the user interface application program 404 that the purchase transaction has been successfully completed. This may occur in accordance with conventional operation of the payment application program 406.

At 628, in response to the indication from the payment application program 406 that the transaction has completed, the user interface application program 404 clears the timer that was set at 620. This also is a conventional function of the user interface application program 404.

Also in response to that indication from the payment application program 406, and as indicated at 630, the user interface application program 404 requests that the environment program 402 clear the alarm that the user interface application program 404 requested at 608. This is a novel function performed by the user interface application program 404 in accordance with aspects of the present invention.

At 632, the environment program 402 responds to the request from the user interface application program 404 by clearing the alarm that was set at 610.

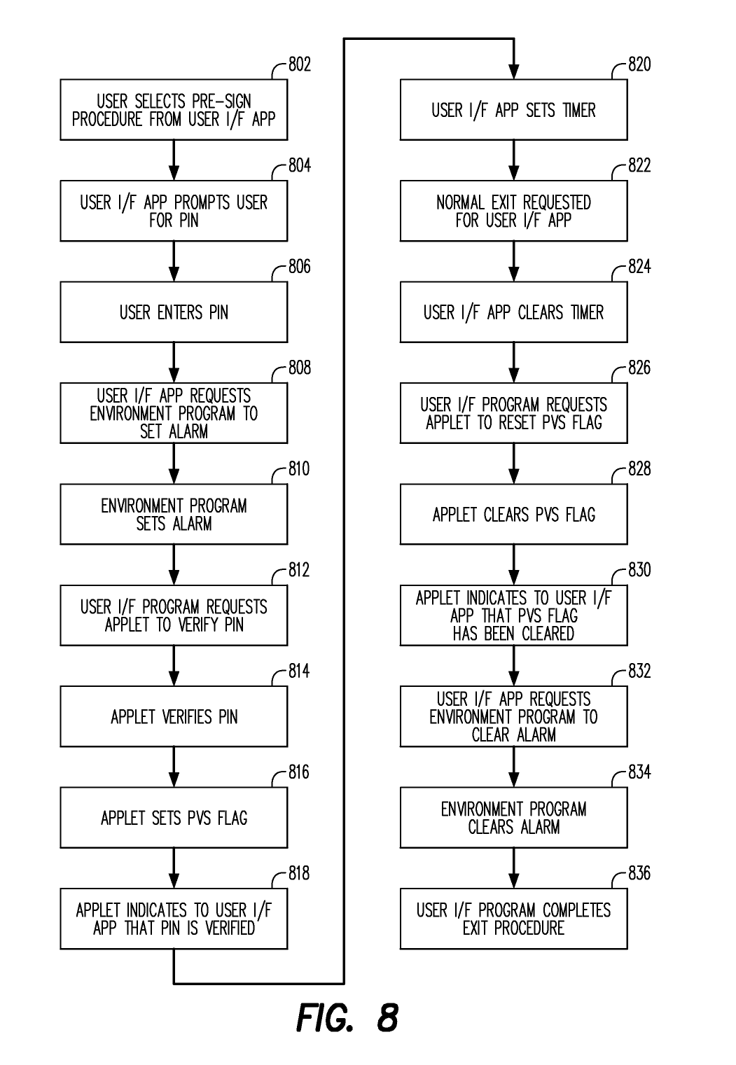

Thus in this “normal transaction” scenario illustrated in FIG. 6, the alarm set via the environment program 402 in accordance with aspects of the present invention is cleared without any need for it to perform the back-up security safeguard function that it fulfills in the case of a scenario of abnormal operation, as described now with reference to FIG. 7.

In FIG. 7, steps 702 through 720 are the same as steps 602-620 as described above in connection with FIG. 6, and therefore need not again be fully described. Nevertheless, to provide context for the balance of FIG. 7, those steps will be briefly summarized: The user selects the pre-sign procedure, and enters his/her PIN in response to a prompt from the user interface application program 404. The environment program 402 sets an alarm in response to a request from the user interface application program 404. The payment application program 406 verifies the user's PIN in response to a request from the user interface application program 404, sets the PVS flag and indicates to the user interface application program 404 that the PIN is verified. Then the user interface application program 404 sets its own timer.

This now brings us to 722, at which an abnormal event occurs in which the user interface application program 404 exits from operation without the usual procedures that are to occur upon shutting down the user interface application program 404. This may happen on occasion because of the complexity of software and/or the occasional unpredictable operation of electronic circuitry, or simply because the user turns off the payment-enabled mobile telephone 102 without signing out from the user interface application program 404.

Following the abnormal exit from the user interface application program 404, the alarm that was set by the environment program 402 at 710 times out, at indicated at 724. Then, at 726, the environment program 402 detects that the alarm has timed out (i.e., the alarm has “gone off” as one would say of an alarm clock), and then in response to detecting the alarm, and as indicated at 728, the environment program 402 triggers a re-start of the user interface application program 404.

At 730 (and as indicated by the above discussion of FIG. 5), the user interface application program 404 requests the payment application program 406 to clear the PVS flag. This occurs in accordance with an aspect of the present invention, and is part of the start-up/initialization process for the user interface application program 404.

At 732, in response to the request from the user interface application program 404, the payment application program 406 clears the PVS flag, thereby taking itself out of its transaction-ready state. Then, at 734, the payment application program 406 indicates to the user interface application program 404 that the PVS flag has been cleared.

In this scenario, the alarm has functioned as a back-up or additional security feature that triggers (indirectly) clearing of the PVS flag so that the payment application program 406 is not indefinitely maintained in a transaction-ready state. In this way the alarm maintained in the environment program 402 backs up the timer maintained within the user interface application program 404 and goes into action after an abnormal exit by the user interface application program 404 to help prevent unauthorized use of the payment-enabled mobile telephone 102 for payment purposes. With the departure of the payment application program 406 from its transaction-ready state, a further entry of the PIN by the user will be required for the next transaction (or the next high value transaction, as the case may be).

According to one alternative embodiment of the process of FIG. 7, at step 728—instead of restarting the user interface application program 404—the environment program 402 initiates operation of a MIDlet other than the user interface application program 404, and the other MIDlet then performs the function indicated at 730—that is, the other MIDlet requests the payment application program 406 to clear the PVS flag.

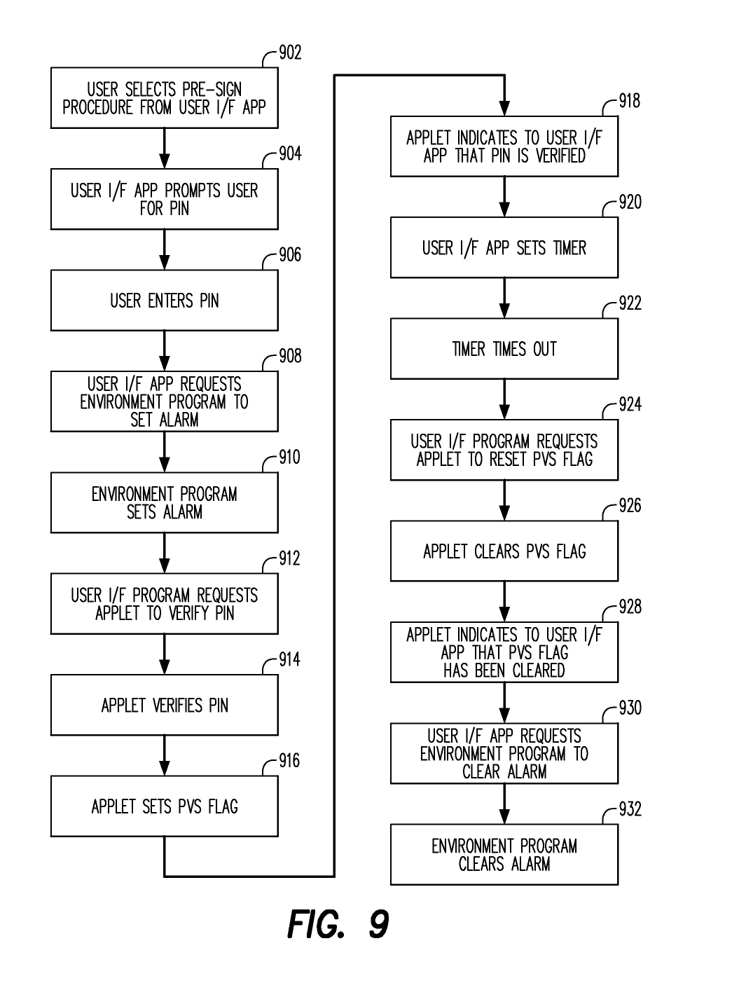

FIG. 8 illustrates the sequence of events that occur in connection with a scenario in which the user interface application program 404 exits in a normal manner. In the process of FIG. 8, steps 802-820 again are the same as steps 602-620 in FIG. 6 (and the same as steps 702-720 in FIG. 7). To again briefly summarize: The user selects the pre-sign procedure, and enters his/her PIN in response to a prompt from the user interface application program 404. The environment program 402 sets an alarm in response to a request from the user interface application program 404. The payment application program 406 verifies the user's PIN in response to a request from the user interface application program 404, sets the PVS flag and indicates to the user interface application program 404 that the PIN is verified. Then the user interface application program 404 sets its own timer.

We now arrive at 822 in FIG. 8. At 822, the user interface application program 404 is requested to exit from operation in a normal manner and proceeds to do so. As part of a normal exit from operation, and as indicated at 824 the user interface application program 404 clears the timer that was set at 820. (This step 824 is the same as step 628 in FIG. 6.)

Then, at 826, the user interface application program 404 requests the payment application program 406 to reset (i.e., to clear) the PVS flag. At 828, in response to this request, the payment application program 406 clears the PVS flag. (Step 828 is the same as step 624 in FIG. 6, and both steps 826 and 828 may be conventional operations of the programs 404 and 406.)

At 830, the payment application program 406 indicates to the user interface application program 404 that the PVS flag has been cleared. In response to this indication, and as represented at 832 in FIG. 8 (and in the same manner as 630 in FIG. 6), the user interface application program 404 requests the environment program 402 to clear the alarm that was set at 810. Then, at 834 (and in the same manner as 632 in FIG. 6), the environment program 402 clears the alarm that was set at 810. Finally, at 836, the user interface application program 404 completes its exit from operation.

In the “normal exit” scenario illustrated in FIG. 8, normal operation of the user interface application program 404 has caused the payment application program 406 to exit from the transaction-enabled state, without any need for execution of the back-up time-out function provided by the alarm maintained at the environment program 402.

We will next turn to a “normal time-out” scenario which is illustrated in FIG. 9.

In the process of FIG. 9, the same events as in steps 602-620 in FIG. 6 (also the same as steps 702-720 and steps 802-820) occur as steps 902-920. To summarize once more: The user selects the pre-sign procedure, and enters his/her PIN in response to a prompt from the user interface application program 404. The environment program 402 sets an alarm in response to a request from the user interface application program 404. The payment application program 406 verifies the user's PIN in response to a request from the user interface application program 404, sets the PVS flag and indicates to the user interface application program 404 that the PIN is verified. Then the user interface application program 404 sets its own timer.

We now come to 922 in FIG. 9. At step 922, the timer set at 920 (and maintained in the user interface application program 404 itself) times out without any transaction having occurred. In response to the timer having timed out, the user interface application program 404 requests (step 924) the payment application program 406 to reset the PVS flag, as in step 826 of FIG. 8. The payment application program 406 does so, at step 926, and as described above in connection with step 828 in FIG. 8. Steps 928, 930, and 932, then follow, and are the same as steps 830, 832 and 834 which were described above. To summarize these last three steps, the payment application program 406 indicates to the user interface application program 404 that the PVS flag has been cleared, the user interface application program 404 requests the environment program 402 to clear the alarm maintained in the environment program 402, and the environment program 402 does so.

Again in the scenario of FIG. 9, it is not necessary for the alarm maintained in the environment program 402 to fulfill its back-up security function, because the timer set within the user interface application program 404 itself operates in this situation to trigger the payment application program 406 back to its non-transaction enabled state.

Although embodiments of the invention have been described above in connection with a mobile telephone, the principles of the present invention are also applicable to incorporation of payment functions in other devices, such as PDAs, MP3 players, etc.

The above description and/or the accompanying drawings are not meant to imply a fixed order or sequence of steps for any process referred to herein; rather any process may be performed in any order that is practicable, including but not limited to simultaneous performance of steps indicated as sequential.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
providing a mobile device, the mobile device including at least one processor, the processor controlled by a plurality of software programs, the software programs including (a) an environment program for supporting application programs, (b) a payment application program for enabling the mobile device to provide payment account information to a point of sale (POS) terminal via radio frequency signaling to consummate a purchase transaction at the POS terminal, and (c) a user interface application program supported by the environment program;
initiating operation of the user interface application program in the mobile device; and
as part of initiating operation of the user interface application program, sending a message from the user interface application program to the payment application program to cause the payment application program to clear a PIN (personal identification number) verification status flag.

2. The method of claim 1, wherein the operation of the user interface application program is initiated by the environment program.

3. The method of claim 2, wherein the environment program initiates operation of the user interface application program in response to timing-out of an alarm maintained in the environment program.

4. The method of claim 3, wherein the alarm is maintained via a push registry.

5. The method of claim 1, wherein the environment program is a virtual machine program.

6. The method of claim 5, wherein the plurality of programs includes a mobile operating system that supports the virtual machine program.

7. The method of claim 1, wherein the mobile device is a payment-enabled mobile telephone.

8. The method of claim 1, wherein the user interface application program includes a function for prompting a user of the mobile device to enter the user's PIN.

9. The method of claim 1, wherein the payment application program is inoperative to enter into the purchase transaction after the PIN verification status flag is cleared.

10. A method comprising:
providing a mobile device, the mobile device including at least one processor, the processor controlled by a plurality of software programs, the software programs including (a) an environment program for supporting application programs, (b) a payment application program for enabling the mobile device to provide payment account information to a point of sale (POS) terminal via radio frequency signaling to consummate a purchase transaction at the POS terminal, and (c) a user interface application program supported by the environment program;
receiving a PIN (personal identification number) from a user of the mobile device via the user interface application program; and
in response to receiving the PIN, the user interface application program requesting the environment program to set an alarm, the alarm having an alarm period.

11. The method of claim 10, further comprising:
the user interface application program setting a time-out period within the user interface application program, the time-out period different from the alarm period.

12. The method of claim 11, further comprising:
the user interface application program experiencing an exit event;
the alarm period expiring;
the environment program responding to expiration of the alarm period by re-initiating operation of the user interface application program; and
in response to re-initiating operation of the user interface application program, sending a message from the user interface application program to the payment application program to cause the payment application program to clear a PIN (personal identification number) verification status flag.

13. The method of claim 11, further comprising:
after setting the alarm and before setting the time-out period:
the user interface application program requesting the payment application program to verify the received PIN; and
the payment application program verifying the received PIN and setting a PIN verification status (PVS) flag.

14. The method of claim 13, further comprising:
the payment application program completing the purchase transaction by providing the payment account information to the POS terminal;
the payment application program clearing the PVS flag;
the payment application program indicating to the user interface application program that the purchase transaction has occurred;
the user interface application program clearing the time-out period;
the user interface application program requesting the environment program to clear the alarm.

15. The method of claim 13, further comprising:
the user requesting the user interface application program to cease operation;
in response to the user requesting the user interface application program to cease operation:
the user interface application program clearing the time-out period;
sending a message from the user interface application program to the payment application program to cause the payment application program to clear the PVS flag;
the payment application program indicating to the user interface application program that the PVS flag has been cleared;
the user interface application program requesting the environment program to clear the alarm; and
the user interface application program ceasing operation.

16. The method of claim 13, further comprising:
the time-out period expiring;
the user interface application program responding to expiration of the time-out period by sending a message from the user interface application program to the payment application program to cause the payment application program to clear the PVS flag;
the payment application program indicating to the user interface application program that the PVS flag has been cleared; and
the user interface application program requesting the environment program to clear the alarm.

17. A mobile device, comprising:
a housing;
a processor contained within the housing; and
a memory contained within the housing and storing a plurality of programs, the plurality of programs including (a) an environment program for supporting application programs, (b) a payment application program for enabling the mobile device to provide payment account information to a point of sale (POS) terminal via radio frequency signaling to consummate a purchase transaction at the POS terminal, and (c) a user interface application program supported by the environment program; the memory in communication with the processor, the processor operative with the programs to:
receive a PIN (personal identification number) from a user of the mobile device via the user interface application program;
in response to receiving the PIN, send a request via the user interface application program to the environment program, the request for requesting the environment program to set an alarm, the alarm having an alarm period;
set a time-out period within the user interface application program, the time-out period different from the alarm period;
experience an exit event in the user interface application program;
detect that the alarm period has expired;
respond to expiration of the alarm period by reinitiating the user interface application program via the environment program; and
in response to reinitiating the user interface application program, send a message from the user interface application program to the payment application program to cause the payment application program to clear a PIN (personal identification number) verification status flag.

18. The mobile device of claim 17, wherein the processor is further operative with the programs, after the alarm is set and before the time-out period is set, to:
request, via the user interface application program, that the payment application program verify the received PIN;
verify the received PIN via the payment application program; and
set the PIN verification status flag in the payment application program.

19. The mobile device of claim 17, wherein the mobile device is a mobile telephone.

20. A method comprising:
providing a mobile device, the mobile device including at least one processor, the processor controlled by a plurality of software programs, the software programs including (a) an environment program for supporting application programs, (b) a payment application program for enabling the mobile device to provide payment account information to a point of sale (POS) terminal via radio frequency signaling to consummate a purchase transaction at the POS terminal, and (c) a user interface application program supported by the environment program;
receiving a PIN (personal identification number) from a user of the mobile device via the user interface application program;
in response to receiving the PIN, the user interface application program requesting the environment program to set an alarm, the alarm having an alarm period;
the user interface application program setting a time-out period within the user interface application program, the time-out period different from the alarm period;
the user interface application program experiencing an exit event;
the alarm period expiring;
the environment program responding to expiration of the alarm period by initiating operation of an application program other than the user interface application program; and
in response to initiation of operation of the application program other than the user interface application program, sending a message from the application program other than the user interface application program to the payment application program to cause the payment application program to clear a PIN (personal identification number) verification status flag.
